(19) United States
(12) Patent Application Publication
(10) Pub. No.: US 2006/0170232 A1
(43) Pub. Date: Aug. 3, 2006

(54) CINECOACH production systems

(76) Inventors: Virgil Eugene Hammond III, Carson City, NV (US); Sheryl Lynn Hammond, Carson City, NV (US)

Correspondence Address: Virgil E. Hammond, III, 1227 Spooner Drive, Carson City, NV, 89706, US

(21) Appl. No.: 10/916,572

(22) Filed: Jan. 25, 2005

(51) Int. Cl. B60P 3/00

(52) U.S. Cl. 296/24.3

(57) ABSTRACT

CINECOACH production systems, was created to provide the Motion Picture and Television Industry with a “Cost Effective” approach to Location and Studio production. CINECOACH production systems is divided into two sections. #1 an Executive Privilege Quarter. Amenities include a Restroom, Kitchen Arrangement, Microwave, Refrigerator, Coffee Maker, Duel Tap Wet Bar, Three Professional DV Recorder/Players for Cameras A/B/C, Three Drop Down 15″ A/B/C Playback Monitors, a Drop Down 20″ Satellite Television System, DVD/CD/VHS player, 5.1 Dolby Pro Logic Surround Stereo System, World Wide Web access via Satellite Connection and On-Board Laptop Editing System Platform for sending Dailies created by DVR/DVB via Wireless Broadband. On-Board Production Computer System is also available. #2, a Motion Picture and Television Equipment Bay includes, Camera, Grip, Lighting, Electrical and Sound. CINECOACH production systems' utility is an actual Bus or Motorcoach 30′ to 56′ in length, 12′.5″ in height and 8′.5″ in width.

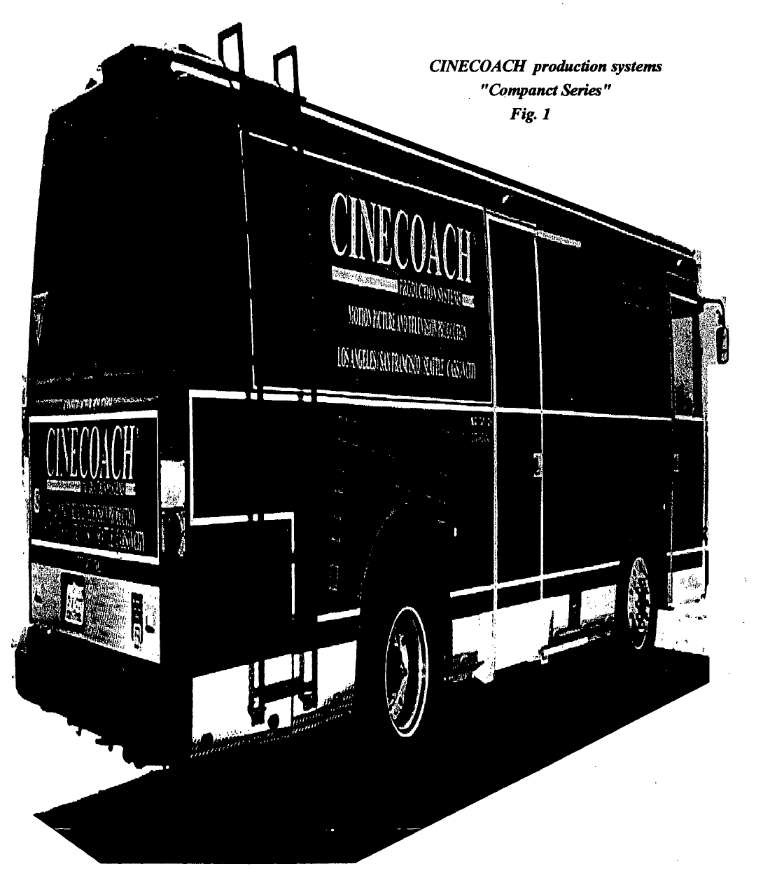

CINECOACH production systems has been solely Developed, Designed, Created and Invented by Producer, Director and Cinematographer, Virgil E. Hammond, III and Executive Producer, Sheryl L. Hammond. The specification of this invention applies to several different versions of CINECOACH production systems with reference to it's utility and design. The purpose of this invention is to provide the motion picture and television industry with a more “cost effective”, “compact” and “executive” solution with regard to location and studio production, therefore drastically reducing the cost of production and enhancing the proficiency of production management. CINECOACH production systems utility consists of a converted or customized transit bus, cross country motor coach, motor home, recreational RV/motor home combination, school bus, 5^{th} wheel trailer and standard trailer configurations, new or in used condition regardless of the original manufacture and it's originally intended use. CINECOACH production systems's utility consists of the above mentioned utilities in sizes ranging from 20′ in length, 8′.5″ in width, 11′.4″ in height to 54′ in length, 8′.5″ in width and 11′.4″ in height. Again, converted or customized from it's originally intended purpose. The utility, for the purpose of this specification, shall also include, a complete and originally designed and manufactured utility including frame, body, motor and transmission configuration with reference to future utility and design claimed above to be manufactured by CINECOACH production systems. CINECOACH production systems utility is divided into two separate sections; #1, an “Executive Privilege Quarter” with restricted access to executive producers, producers, associate producers, editors, assistant editors, directors of photography, and certified CINECOACH production systems specialists. The decor resembles that of a “Las Vegas” type hotel quarter, complete with various amenities such as a complete kitchen arraignment including a microwave oven, refrigerator, coffee maker, duel tap wet bar, small executive restroom, three professional digital recorder/players for cameras A/B/C, three drop down 15″ color NTSC certified monitors for video assist, live telecasts, live to tape production, live event IMAG production, and a 20″ drop down color NTSC certified monitor as an additional source or program monitor complemented with a professional audio and video switcher commonly utilized with the above formatted productions. A DVD/CD/VHS recorder/player, a 5.1 Dolby Pro Logic 11 certified surround sound stereo system and an on-board desk top or lap top professional editing system platform is also available. World Wide Web access via telephone, wireless or satellite connection, with 100 percent digital quality and a standard on-board computer and printer system is also available for production management.

Section #2, an “Motion Picture and Television Equipment Bay”, with it's own entrance providing access to any and all motion picture and television production equipment required for production as it relates to industry standards. This equipment includes the required film (16 mm/35 mm/digital cinematography) and or video (standard definition (SD)/high definition video (HDV)/high definition television (HDTV) camera equipment, grip equipment, lighting equipment, electrical equipment, set rigging equipment and special effects equipment. A collapsible craft service table is also affixed to the outside of CINECOACH for cast, crew and executive use.

What we claim as our invention is:

1. CINECOACH production systems utility design consisting of a,
Bus/Transit Bus/Motorcoach/Coach or Motor Home,
30′ to 56′ in length, 12′.5″ in height and 8′.5″ in width,
capable of transporting 30 cast and crew members and it's required film and video production equipment weather it be for studio or location production.

2. Executive Quarter utility design encompassed with the abilities of providing motion picture and television production,
Film or video and computer generated retrieval,
Basic editing, special effects,
Broadcasting film and video product via satellite regardless of technology,
“End User” capable of retrieving such film and video product via computer abilities,
required for commercial and industry purposes, weather it be for studio or location production.

3. Motion Picture and Television Equipment Bay utility design encompassed with the abilities of transporting and providing the industry standard production equipment required including,
Camera,
Grip,
Lighting,
Electrical,
Sound,
for commercial and industry purposes, weather it be for studio or location production.

4. CINECOACH production systems industry standard camera equipment being claimed as,
Video, all pro-summer and professional NTSC, PAL, SECAM, Digital and Hi-Definition,
Formats, Hi-8, Mini Digital, Professional DV, Betacam-SP, D1, D2, D3, D4, D5,
24p and tapeless field recording systems,
Film, 8 mm, super 8 mm, 16 mm, super 16 mm, 35 mm, super 35 mm, 65 mm, 70 mm formats.

5. CINECOACH production systems industry standard grip equipment being claimed as, Grip, industry standard.

6. CINECOACH production systems industry standard lighting equipment being claimed as,
Lighting, all tungsten, HMI and fluorescent fixtures.

7. CINECOACH production systems industry standard electrical equipment being claimed as,
Electrical, industry standard.

8. CINECOACH production systems industry standard sound equipment being claimed as,
Sound, industry standard.
